(19) United States
(12) Patent Application Publication
(10) Pub. No.: US 2014/0362170 A1
(43) Pub. Date: Dec. 11, 2014

(54) VIDEO CONFERENCE SYSTEM AND METHOD FOR MAINTAINING PARTICIPANT EYE CONTACT

(71) Applicant: Mark Leroy Walker, Castaic, CA (US)

(72) Inventor: Mark Leroy Walker, Castaic, CA (US)

(73) Assignee: THOMSON LICENSING, Issy de Moulineaux (FR)

(21) Appl. No.: 14/376,963

(22) PCT Filed: Feb. 15, 2012
(86) PCT No.: PCT/US12/25155

§ 371 Date: Aug. 6, 2014

(51) Int. Cl. H04N 7/15

(52) U.S. Cl. CPC H04N 7/15
USPC 348/14.08

(57) ABSTRACT

Eye contact between remote and local video conference participants is advantageously maintained by displaying the face of a remote video conference so the remote video conference participant having his or her eyes positioned in accordance with information indicative of image capture of the local video conference participant. In this way, substantial alignment can be achieved between the remote participant's eyes with those of the local participant.

### TECHNICAL FIELD

This invention relates to a technique for providing an improved video conference experience for participants.

### BACKGROUND ART

Typical video conference systems, and even simple video chat applications, include a display screen (e.g., a video monitor) and at least one television camera, with the camera generally positioned atop the display screen. The television camera provides a video output signal representative of an image of the participant (referred to as the “local” participant) as he or she views the display screen. As the local participant looks at the image of another video conference participant (a “remote” participant) on the display screen, the image of the local participant captured by the television camera will typically portray the local participant as looking downward, thus failing to achieve eye contact with the remote participant.

A similar problem exists with video chat on a tablet or a “Smartphone.” Although the absolute distance between the center of the screen of the table or Smartphone (where the image of the remote participant's face appears) and the device camera remains small, users typically operate these devices in their hands. As a result, the angular separation between the sightline to the image of the remote participant and the sightline to the camera remains relatively large. Further, device users typically hold these devices low with respect to the user's head, resulting in the camera looking up into the user's nose. In each of these instances, the local participant fails to experience the perception of eye-contact with the remote participant.

The lack of eye-contact in a video conference diminishes the effectiveness of video conferencing for various psychological reasons. See, for example, Bekkering et al., “i2i Trust in Video Conferencing”, Communications of the ACM, July 2006, Vol. 49, No. 7, pp. 103-107. Various proposals exist for maintaining participant eye contact in a video conferencing environment. U.S. Pat. No. 6,042,235 by Machtig et al. describes several configurations of an eye contact display, but all involve mechanisms, typically in the form of a beam splitter, holographic optical element, and/or reflector, to make the optical axes of a camera and display collinear. U.S. Pat. Nos. 7,209,160; 6,710,797; 6,243,130; 6,104,424; 6,042,235; 5,953,052; 5,890,787; 5,777,665; 5,639,151; and 5,619,254) all describe similar configurations, e.g., a display and camera optically superimposed using various reflector/beam splitter/projector combinations. All of these systems suffer from the disadvantage of needing a mechanism that combines the camera and display optical axes to enable the desired eye-contact effect. The need for such a mechanism can intrude on the user's premise. Even with configurations that try to hide such an axes-combining mechanism, the inclusion of such a mechanism within the display makes display substantially deeper or otherwise larger as compared to modern thin displays.

To avoid the need make the television camera and display axes co-linear, some teleconferencing systems synthesize a view that appears to originate from a “virtual” camera. In other words, such systems interpolate two views obtained from a stereoscopic pair of cameras. Examples of such system include Ott, et al., “Teleconferencing Eye Contact Using a Virtual Camera”, INTERCHI'93 Adjunct Proceedings, pp 109-110, Association for Computing Machinery, 1993, ISBN 0-89791-574-7; and Yang et al., “Eye Gaze Correction with Stereovision for Video-Teleconferencing”, Microsoft Research Technical Report MSR-TR-2001-119, circa 2001. However, these systems do not compensate for images of the remote participant that appear off-center in the field of view. For example, Ott et al. suggest compensating for such misalignment by shifting half of the disparity at each pixel. Unfortunately, no amount of interpolation performed by such prior-art systems yield a sense of eye contact if the remote participant does not appear precisely in the middle of the stereoscopic field. The resulting virtual camera image produced by such prior art systems still present the remote participant off-center, resulting in the local participant appearing to gaze away from the center of the display, so the local participant appears to look away from the location of the local virtual camera.

Thus, a need exists for a teleconferencing technique which eliminates the need for intrusive reflective surface and the need to increase the depth of the combined television camera/display mechanism, yet provide the perception of eye-contact needed for high quality teleconferencing.

### BRIEF SUMMARY OF THE INVENTION

Briefly, in accordance with a preferred embodiment of the present principles, a method for maintaining eye contact between a remote and a local video conference participant commences by displaying a face of a remote video conference participant to a local video conference participant with the remote video conference participant having his or her eyes positioned in accordance with information indicative of image capture of the local video conference participant to substantially maintain eye contact between participants.

### BRIEF DESCRIPTION OF THE DRAWINGS

FIG. 1 depicts block diagram of a terminal comprising part of a telepresence communication system in accordance with a preferred embodiment of the present principles;

FIG. 2 depicts a pair of the terminals of FIG. 1 comprising a telepresence communication system in accordance with a preferred embodiment of the present principles;

FIGS. 3A and 3B depict images captured by each of a pair of stereoscopic cameras comprising part of the terminal of FIG. 1

FIG. 4 depicts an image synthesized from the images of FIGS. 3A and 3B to simulate a view of a virtual camera located midway between the stereoscopic cameras of the terminal of FIG. 1;

FIG. 5 depicts the image of FIG. 4 during subsequent processing to detect the face and the top of the head of a video conference participant and to establish cropping parameters;

FIG. 6 depicts a first exemplary image displayed by a video monitor of the terminal of FIG. 1 showing a remote video conference participant superimposed on video content;

FIG. 7 depicts a second exemplary image displayed by a video monitor of the terminal of FIG. 1 showing a remote video conference participant superimposed on video content;

FIG. 8 depicts a flowchart of exemplary processes executed by the terminal of FIG. 1 for achieving eye-contact between video conference participants; and,

FIG. 9 is a streamlined flowchart showing a single exemplary essential process for execution by the terminal of FIG. 1 for achieving eye-contact between video conference participants.

### DETAILED DESCRIPTION

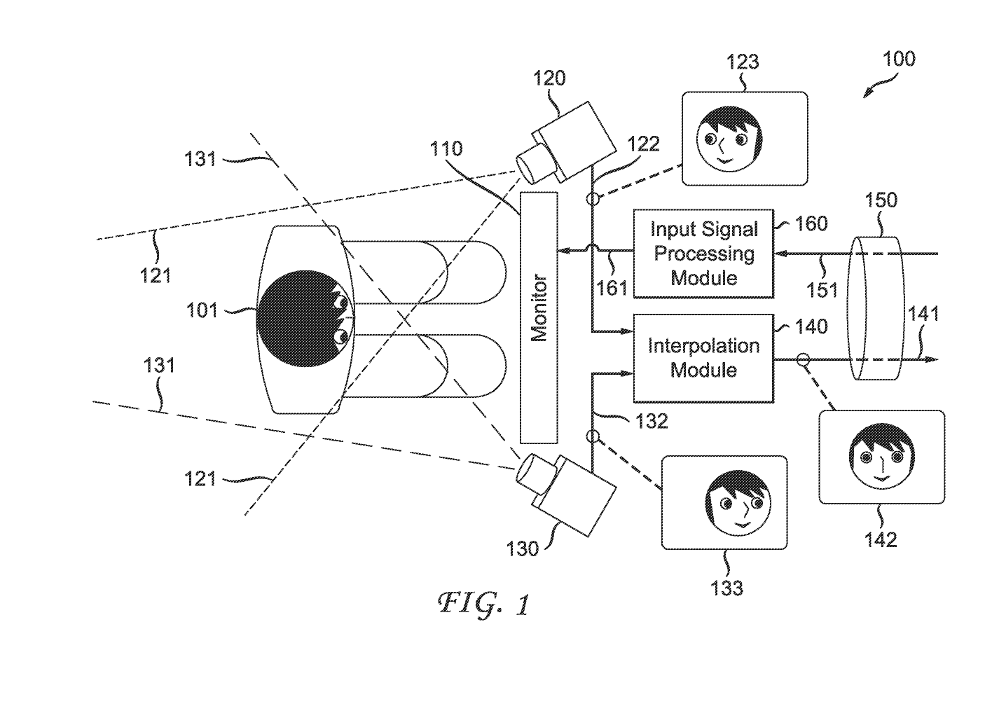

FIG. 1 depicts a block schematic diagram of an exemplary embodiment of a terminal 100 for use as part of a video teleconferencing system by a video conference participant 101 to interact with one or more other participants (not shown), each using a terminal (not shown) similar to terminal 100. For reference purposes, FIG. 1 depicts a top view of the participant 101. The terminal 100 includes a video monitor 110 which displays images, including video content (e.g., movies, television programs and the like) as well as an image of one or more remote video conference participants (not shown). A pair of horizontally opposed television cameras 120 and 130 lie on opposite sides of the monitor 110 to capture stereoscopic views of the participant 101 when the participant resides within the intersection of the fields of view 121 and 131 of cameras 120 and 130, respectively.

For ease of reference, the participant who makes use of a terminal, such as terminal 100 will typically bear the designation “local” participant. In contrast, the video conference participant at a distant terminal, whose image undergoes display on the monitor 110, will bear the designation “remote” participant. Thus, same participant can act as both the local and remote participant, depending on the point of reference with respect to the participant's own terminal or a distant terminal.

As depicted in FIG. 1, the cameras 120 and 130 toe inward but need not necessarily do so. Rather, the cameras 120 and 130 could lie parallel to each other. The cameras 120 and 130 generate video output signals 122 and 132, respectively, representative of images 123 and 133, respectively, of the participant 101. The video images 123 and 133 generated by cameras 120 and 130, respectively, can remain in a native form or can undergo one or more processing operations, including encoding, compression and/or encryption without departing the present principles as will become better understood hereinafter.

The images 123 and 133 of the participant 101 captured by the cameras 120 and 130, respectively, form a stereoscopic image pair received by an interpolation module 140 that can comprise a processor or the like. The interpolation module 140 executes software to perform a stereoscopic interpolation on the images 123 and 133, as known in the art, to generate a video signal 141 representative of a synthetic image 142 of the participant 101. The synthetic image 142 simulates an image that would result from a camera (not shown) positioned at the midpoint between cameras 120 and 130 with an orientation that bisects these two cameras. Thus, the synthetic image 142 appears to originate from a virtual camera (not shown) located within the display screen midway between the cameras 120 and 130.

The video signal 141, representative of the synthetic image 142, undergoes transmission through a communication channel 150, to one or more remote terminals for viewing each remote participant (not shown) associated with a corresponding remote terminal. In addition to generating the video signal 141 representing the synthetic image of the participant 101, the terminal 100 of FIG. 1 typically receives, via the communication channel 150, a video signal 151 representing the synthesized image (not shown) of a remote video conference participant. An input signal processing module 160 within the terminal 101, typically in the form of a processor programmed in the manner described hereinafter, processes the incoming video signal 151. In particular, the input signal processing module 160 processes the incoming video signal 151 to detect the face of the remote participant as well as to center that face and scale its size. Thus, the input signal processing module 160 will detect a human face within the synthetic image of the remote participant represented by the incoming video signal 151. Further, the input signal processing module 160 will determine the top of the head corresponding to the detected face which, as described hereinafter, allows for centering of the remote participant's eyes within the image displayed to a local participant in accordance the image capture position of the local participant with the to maintain eye contact therebetween.

To detect the top of the remote participant's head, the input signal processing module 160 typically constructs a bounding box about the remote participant's head. The input signal processing module 160 does this by mirroring the top of the head (as detected) below and to either side of the head, with respect to the detected centroid of the remote participant's face. The synthetic image representing the remote participant then undergoes cropping to this bounding box (or to a somewhat larger size as a matter of design choice). The resulting cropped image undergoes scaling, either up or down, as necessary, so that pixels representing the remote participant's head will approximate a life-size human head (e.g., the pixels representing the head will have appear to have a height of about 9 inches).

Following the above-described image processing operations, the input signal processing module 160 generates a video output signal 161 representative of a cropped (synthetic) image of the remote participant for display on the video monitor 110 for viewing by the local participant. The displayed image will appear substantially life-sized to the participant 101. In some embodiments, metadata could accompany the incoming video signal 151 representative of the remote participant synthetic image to indicate the actual height of the remote participant's head. The input signal processing module 160 would make use of such metadata to in connection with the scaling performed by this module.

In the illustrated embodiment of FIG. 1, interpolation of the local participant's synthetic image for transmission to the remote participant, and processing of the incoming video signal 151 to detect, center and scale the face of the remote participant, all occur within the terminal 100 associated with the participant 101. However, either or both of these functions could reside within the terminal (not shown) associated with the remote video participant. In other words, all or part of the generation of synthetic image 142 could occur on the far side of the communication channel 150 (i.e., at the terminal of the remote video conference participant). In a symmetrical implementation, that would mean that the local terminal would receive a stereoscopic image pair of the remote participant (not shown in FIG. 1) and the stereoscopic image pair would undergo local interpolation to produce the remote participant synthetic image, which would then subsequently undergo processing by the input signal processing module 160.

By example and not by way of limitation, the communication channel 150 could comprise a dedicated point-to-point connection, a cable or fibre network, a wireless connection (e.g., Wi-Fi, satellite), a wired network (e.g., Ethernet, DSL), a packet switched network, a local area network, a wire area network or the Internet or any combination thereof. Further, the communication channel 150 need not provide symmetric communication paths. In other words, the video signal 141 need not travel by the same path as the video signal 151. In practice, the channel 150 will include one or more pieces of communications equipment, for example, appropriate interfaces to the communication medium (e.g., a DSL modem where the connection is DSL).

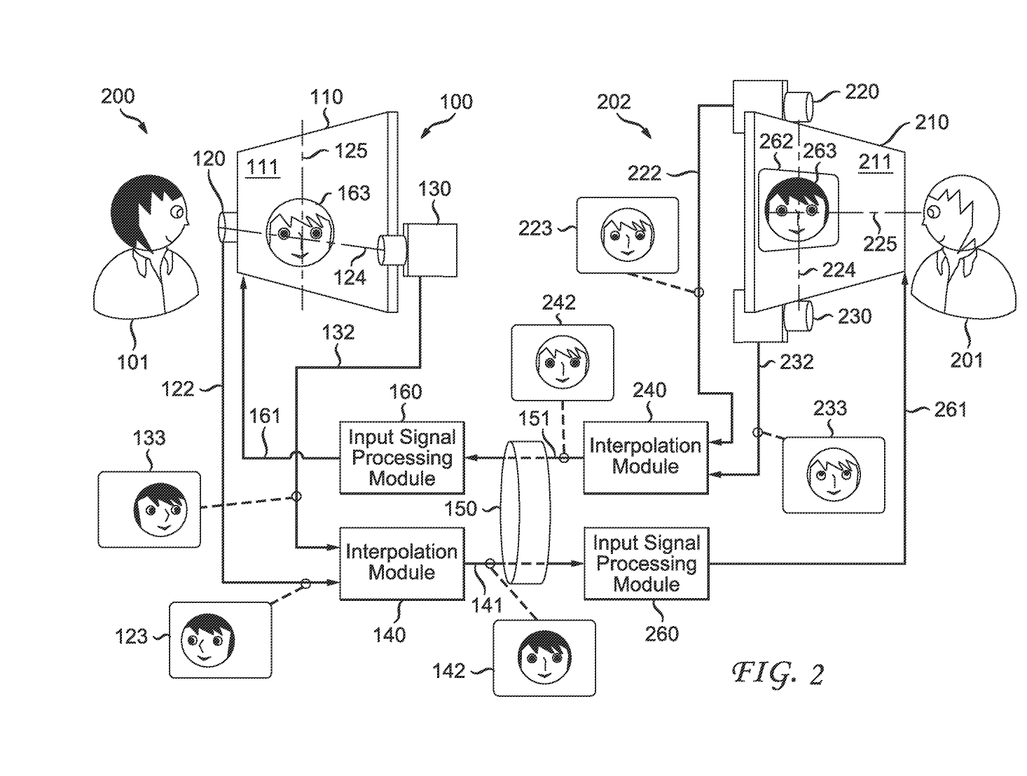

FIG. 2 illustrates a telepresence communication system 200 in accordance with a preferred embodiment of the present principles. The system 200 includes the terminal 100 described in FIG. 1 for use by the participant 101. The communications channel 150, also described in FIG. 1, connects the terminal 100 to a second terminal 202 used by a participant 201. The second terminal 202 has a structure corresponding to the terminal 100 of FIG. 1. In that regard, the second terminal 202 comprises a video monitor 210 and a pair of television cameras 220 and 230. The television cameras 220 and 230 could lie parallel as shown, or could toe-in towards each other as in the case of the terminal 100 of FIG. 1 as part of camera alignment prior to calibration. The television cameras 220 and 230 generate video output signals 222 and 232, respectively, representing the images 223 and 233, respectively, of the participant 201. An interpolation module 240, similar to the interpolation module 140 of FIG. 1, receives the video output signals 222 and 232 and interpolates the images 223 and 233, respectively, to yield the video output signal 151 representative of a synthetic image 242 of the participant 201. As discussed previously, the communication channel 150 carries the video output signal 151 of the terminal 201 to the terminal 100.

Like the terminal 100 with its input signal processing module 160, the terminal 202 includes an input signal processing module 260 that receives the video output signal 151 from the terminal 100 via the communication channel 150. The input signal processing module 260 performs face detection, centering, and scaling on the incoming video signal 151 to yield a cropped, substantially life-sized synthetic image of the a remote participant (in this instance, the participant 101) for display on the monitor 210.

In the illustrated embodiment, the terminals 100 and 202 depicted in FIG. 2 differ with respect to their camera orientation. The cameras 120 and 130 of the terminal 100 have the same horizontal orientation and lie at opposite sides of the monitor 110. In contrast, the cameras 220 and 230 of terminal 202 have the same vertical orientation and lie at the top and bottom of the monitor 210. Thus, the image 123 captured by the camera 120 of the terminal 100 shows the participant 101 more from the left, whereas the image 133 captured by the camera 130 shows the participant 101 more from the right. In contrast, the image 223 captured by the camera 220 of terminal 202 shows the participant 202 somewhat more from above, whereas the image 233 captured by the camera 230 shows participant from somewhat more from below. Given the difference in camera orientations, the image interpolation module 140 of the terminal 100 performs a horizontal interpolation on the stereoscopic image pair 123 and 133, respectively, whereas the image interpolation module 240 of the terminal 202 performs a vertical interpolation on the stereoscopic image pair 223 and 233.

In some embodiments, the processing of the incoming synthetic image by a corresponding one of the input signal processing modules 160 and 260 of terminals 100 and 200, respectively, of FIG. 2 results in detection of portions of the images residing in the background in addition to detection of the video participant's face. Upon detection of the images residing in the background, the corresponding input signal processing module can recognize that certain portions of the respective images remain substantially unchanging over a predetermined timescale (e.g., over several minutes). Alternatively, the corresponding input signal processing module could recognize that the binocular disparity in certain regions of the incoming synthetic image of the remote participant appears substantially different than the binocular disparity corresponding to the region in which the detected face appears. Under such circumstances, the corresponding input signal processing module can subtract the background region from the synthetic image such that when the synthetic image undergoes display to a local participant, the background does not appear.

To produce the desired eye-contact effect in accordance with the present principles, the eyes of a remote participant appearing in the synthetic image should appear such that eyes lie at the midpoint between the two local cameras regardless of scale. To that end, the screen 111 of the monitor 110 of terminal 100 of FIG. 2 will display the synthetic image 163 of the participant 201 with the participant's eyes substantially aligned with a horizontal line 124 running between the cameras 120 and 130 and substantially bisected by a vertical centerline 125 bisecting the line 124. Likewise, the screen 211 of the monitor 210 will display the synthetic image 263 of the participant 101 with the participant's eyes is displayed substantially bisected by the vertical line 224 running between cameras 220 and 230, and substantially aligned with a horizontal centerline 225 bisecting line 224. As a design decision, the image 263 of the remote participant displayed by the monitor 210 could lie within a graphical window 262.

Positioning the synthetic image in the manner described above results in the synthetic image appearing overlay the field of view a virtual camera (not shown) located substantially coincident with the centroid of the displayed image of the remote participant. Thus, when a local participant views his or her monitor, that participant will perceive eye contact with remote participant. The perceived eye-contact effect typically will not occur if the eyes of the remote participant do not lie substantially co-located with the intersection of the line between the two cameras and the bisector of that line. Thus, with respect to terminal 100, the perceived eye-contact effect will not occur should the eyes of the remote participant appearing in the image 163 not lie substantially co-located with intersection of the lines 124 and 125.

Note that even if a local participant looks directly at the eyes of a remote participant whose image undergoes display on the local participant's monitor, the desired effect of eye contact may not occur unless the image of the remote participant remains positioned in the manner discussed above. If the image of the remote participant remains off center, then even though the local participant looks direct at the eyes of the remote participant, the resultant image displayed to remote participant will depict the local participant as looking away from the remote participant.

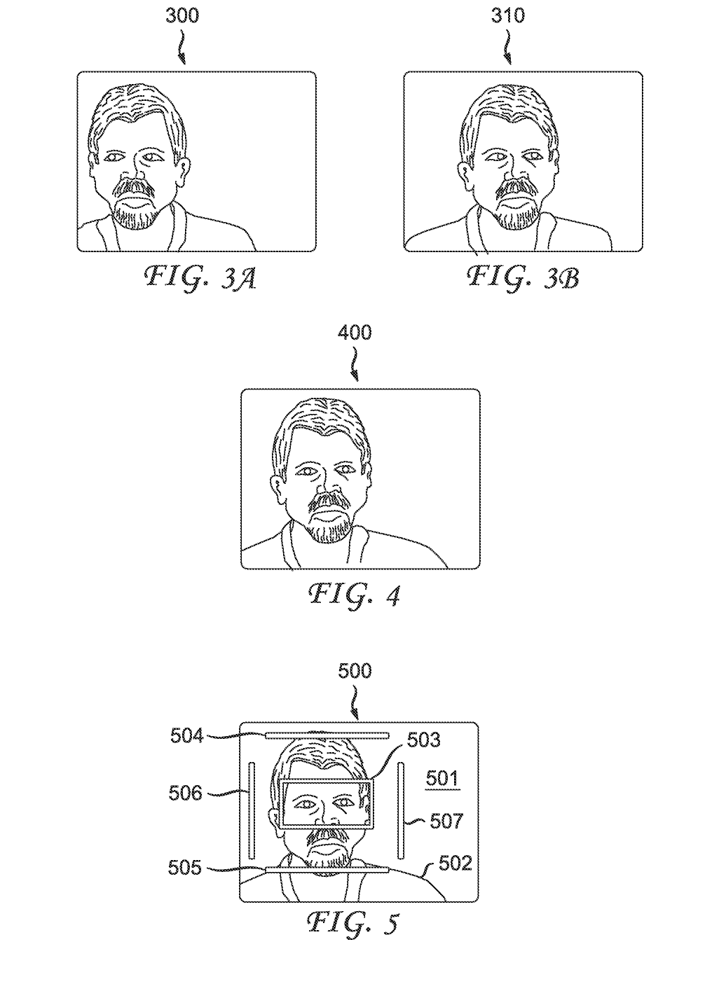

FIGS. 3A and 3B depicts show images 300 and 310, respectively, each representative of the images simultaneously captured by a separate the cameras 120 and 130, respectively, of FIGS. 1 and 2. The image 300 of FIG. 3A corresponds to the image 123 of FIGS. 1 and 2. Likewise, the image 310 of FIG. 3B corresponds to the image 133 of FIGS. 1 and 2. FIG. 4 shows a synthetic image 400 obtained by the interpolation of the two images 300 and 310 of FIG. 3 performed by the image interpolation module 140 of FIGS. 1 and 2, and corresponding to the image 142 of FIGS. 1 and 2. Image 400 represents the image that would be obtained from a virtual camera located at the intersection of lines 125 and 124 in FIG. 2. Various techniques for image interpolation remain well-known, and include the interpolation techniques taught by Criminisi et al. in U.S. Pat. No. 7,809,183 and by Ott et al., op. cit.

FIG. 5 depicts an image 500 produced during of processing of the image 400 of FIG. 4 by the input signal processing module 160 of FIGS. 1 and 2. The image 500 has a background region 501 that appears substantially stationary and unchanging over meaningful intervals (e.g., minutes). For that reason, the input signal processing module 160 of FIGS. 1 and 2 can memorize and recognize the background region 501 of FIG. 5. Within the image 500, a video conference participant 502 can move within the frame, or enter or leave the frame to be substantially distinguishable from the background region.

The input signal processing module 160 of FIGS. 1 and 2 executes a face detection algorithm, well-known in the art, to search for and find a region 503 in the image 500 that matches the eyes of a video conference participant 502 with sufficiently high confidence. (For this reason, the region 503 will bear the designation as the “eye region.”) Such algorithms can similarly detect the human eye region even if the video conference participant 502 wears a wide variety of eye glasses (not shown). The face detection search can operate in a more efficient manner by disregarding all or part the background region 501 and only search that part of the image not considered as part of the background region 501. In other words, the face detection search can simply consider the area occupied by the video conference participant 502 of FIG. 5.

Once the face detection algorithm has identified the eye region 503, the algorithm can search upward within the image above the eye region for a row 504 corresponding to the top of the head of the video conference participant 502. The row 504 in the image 500 lies above the eye region 503 and resides where the video conference participant does not reside and the background region 501 exists. In practice, the human head exhibits symmetry such that the eyes lie approximately midway between the top and bottom of the head. Within the image 500, the row 505 corresponds to the bottom of the head of the video conference participant 502.

The input signal processing module 160 of FIGS. 1 and 2 can estimate the position of the row 505 of FIG. 5 as residing below the horizontal centerline of the eye region 503 whereas the row 504 lies above that centerline. To complete a bounding box around the head of the video conference participant 502, the input signal processing module 160 can place a pair vertical edges 506 and 507 illustrated in FIG. 5 to frame the head in a predetermined aspect ratio. In practice, the horizontal displacement of edges 506, 507 from the vertical centerline of the detected eye region 503 corresponds to the predetermined aspect ratio multiplied by the distance from the horizontal centerline of the eye region 503 to the row 504. If desired, the input signal processing module 160 of FIGS. 1 and 2 can expand the bounding box defined by edges 504-507 to avoid tightly the cropping of the hair and chin or/beard of the video conference participant near the edges 504 and 505 of FIG. 5.

Further, the input signal processing module 160 of FIGS. 1 and 2 can scale the image 500 of FIG. 5 based on the vertical height in the rows of the bounding box and the height of individual pixel rows in the display, Typically the scaling occurs so that upon display of the image of the video conference participant 502 (corresponding to the remote video conference participant referred to with respect to FIGS. 1 and 2), the vertical height between the original bounding box edges 504 and 505 corresponds to approximately nine inches, the average height of an adult human head. In some instances, the actual height of the height of the video conference participant 502 exists in metadata supplied to the input signal processing module 160 of FIGS. 1 and 2. Thus, under such circumstances, the input signal processing module 160 will use such metadata to scale the size of the head, rather than using the default value of nine inches.

The input signal processing module 260 of FIG. 2 operates in the same manner as the input signal processing module 160 of FIGS. 1 and 2. Thus, the above discussion of the manner in which the input signal processing module 160 of FIGS. 1 and 2 performs face detection, cropping, and scaling applies equally to the input signal processing module 260 of FIG. 2.

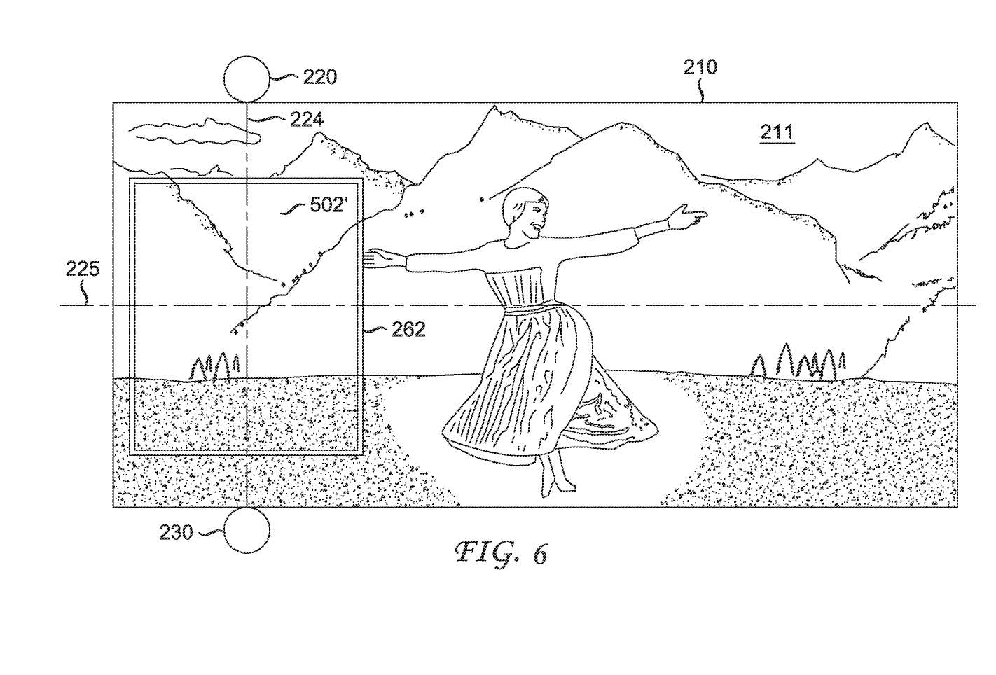

FIG. 6 shows an image 211 representative of content (e.g., a movie or television program) displayed on the monitor 210. A graphical window 262 within the image 211 contains an image 502′ of the video conference participant 502 of FIG. 5 scaled in the manner described above. The head of the video conference participant within the image 502′ has a height of approximately nine inches tall (or the head's actual height, as previously described). When displayed within the window 262, the center of the eyes of the video conference participant in the image 502′ will substantially coincide with the intersection of the vertical centerline 224 of the cameras 220 and 230 of FIG. 2 and the horizontal line 225 bisecting the camera center line 224.

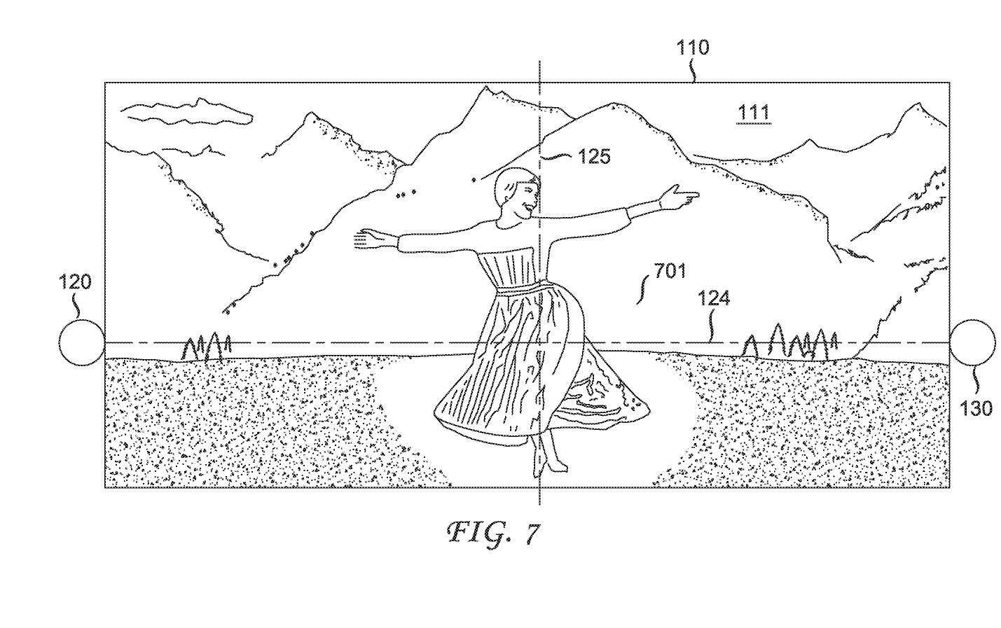

FIG. 7 depicts the monitor 110 of FIGS. 1 and 2 as it displays an image 111, for example the same movie appearing in the image 211 displayed by the monitor 210 in FIG. 6. However, unlike the image 211 of FIG. 6, which contains the graphical window 262, the image 111 in FIG. 6 contains no such window. In contrast, the image 111 contains an image 701 of the remote participant alone, with the background removed. Thus, during the processing of the video signal 151 of FIG. 1, the input signal processing module 160 of FIG. 1 will render transparent the back ground region (the region 501 in FIG. 5). Thus, when overlayed on the image 111 of FIG. 7, the image 701 of the remote participant contains substantially no background. Instead, the displayed content (e.g., the movie) shows through in lieu of displaying the background region of the remote participant. Rendering the background of the image of the remote participant avoids any distraction associated with movement of the remote participant. If the remote participant does from move side-to-side and/or up-and-down, input signal processing unit 160 of FIGS. 1 and 2 will track this movement and substantially cancel it, keeping the head of the remote participant displayed at substantially at the centroid of the virtual camera location on the monitor 110 of FIGS. 1 and 2.

As discussed above with respect to FIGS. 6 and 7, each of the monitors 110 and 210 overlays a display of the remote video conference participant, as properly scaled, onto the content displayed by that monitor. The content displayed by the monitors 110 and 210 in FIGS. 6 and 7 can originate from one or more external sources (not shown) such as set-top box (e.g., for cable, satellite, DVD player, or Internet video), a personal computer, or other video source. The eye-contact obtained in accordance with the present principles does not require the need for an external video source. Further, each of the monitors need not use the same external video source nor does synchronism need to exist between external video sources. Techniques for overlaying one video signal (i.e., the signal representative of the remote participant) onto another signal (i.e., the signal representing the video content) remain well-known, both for with and without transparent regions (as shown in FIGS. 7 and 6, respectively).

FIG. 8 depicts in flow chart form the steps of a telepresence processes 800 for achieving eye contact between participants in a video conference in accordance with the present principles. The telepresence process 800 begins at step 801 once two terminals (such as terminals 100 and 202 of FIGS. 1 and 2) connect to each other through a communication channel (such as the communications channel 150 of FIGS. 1 and 2). As discussed previously, to achieve eye contact between participants, the terminal associated with each participant performs certain operations on the outgoing and incoming video signals. Stated another way, each terminal performs certain operations on the outgoing image of the local participant and the incoming image of a remote participant. For ease of discussion, all of the steps of the telepresence process 800 depicted in FIG. 8 that lie above the line 807 typically take place at a first terminal (e.g., terminal 100 of FIGS. 1 and 2). In contrast, all the operations that lie below line 807 take place at a second terminal (e.g., terminal 201 of FIG. 2). However, as discussed above, both terminals typically perform the same steps.

During steps 802 and 803 of FIG. 8, the first and second cameras (e.g., the cameras 120 and 130 of FIGS. 1 and 2) of a first terminal (e.g., the terminal 100 of FIGS. 1 and 2) capture first and second images, respectively, (e.g., the images 123 and 133, respectively, of FIGS. 1 and 2) of the local participant (e.g., the participant 101 of FIGS. 1 and 2). As discussed above, the images captured by two the cameras of each terminal undergo interpolation to yield a synthetic image. Such interpolation can occur at the local terminal (i.e., the terminal whose cameras originated the images). Alternatively, such interpolation can occur at a remote terminal (i.e., the terminal receives such images). The process 800 follows the processing path 805 when interpolation occurs within the local terminal as discussed above with respect to the telepresence system of FIG. 2.

When following the process path 805, a process block 820 will commence execution following step 803. The process block 820 of FIG. 8 commences with the step 821, whereupon the local interpolation module (e.g., the interpolation 140 of FIGS. 1 and 2) interpolates the two captured images (e.g., the images 123 and 133 of FIGS. 1 and 2) to synthesizes a synthetic image (e.g., the synthetic image 142). Step 822 follows step 221. During execution of step 821, the local interpolation module transmits the synthetic image via the communication channel 150 of FIG. 1 to the second terminal (e.g., the terminal 202 of FIG. 2). At this juncture, execution of the process block 820 ends and subsequent processing of the synthetic image begins at a remote terminal. For this reason, the process steps executed subsequently to the steps in process block 820 lie below the line 807.

The telepresence process 800 includes a process block 830 executed by each of the input signal processing input signal processing modules 160 and 260 at each of the terminals 100 and 201, respectively, to perform face detection and centering on the incoming image of the remote participant. Upon receipt of a synthetic image representing the remote video conference participant, the input signal processing module first locates the face of that participant during step 831 in the process block 830. Next, step 832 of FIG. 8 undergoes execution, whereupon the input signal processing module determines whether the face detection previously made during step 831 occurred with sufficient confidence. If so, step 833 undergoes execution to indentify the top of the remote participant's head (i.e., the location of the row 504 in FIG. 4) as well as to establish the bounding box formed by the rows 504 and 504 and the edges 506 and 507.

The height of this bounding box corresponds to height the head of the remote participant ultimately displayed (e.g., nine inches tall) or at the actual head height as determined from metadata supplied to the input signal processing module. Expanding the size of the bounding will make the displayed height proportionally larger. The parameters associated with bounding box location undergo storage in a database 834 as “crop parameters” which get used during a cropping operation performed on the synthetic image during step 835.

If the input signal processing module did not detect the remote participant's face with sufficient confidence during step 832, then step 836 undergoes execution. During step 836, the input signal processing selects the previous crop parameters that existed prior the storage and then proceeds to step 835 during which such prior crop parameters serve as the basis for conducting the cropping of the image. Execution of the process block 830 ends following step 835.

Step 840 follows execution of the step 835 at the end of the process block 830. During step 840, the monitor displays the cropped image of the remote video conference participant, as processed by the input signal processing module. Processing of the cropped image for display takes into account information stored in a database 841 indicative of the position of the cameras with respect to the monitor displaying that image, as well as the physical size of the pixels, and the physical size of the monitor and the pixel resolution used to scale the cropped synthetic image. In this way, the displayed image of the remote video conference participant will appear with the correct size and at the proper position on the monitor screen so that the remote and local participants' eyes substantially align.

As discussed above, while image interpolation can occur at the terminal that captured such images, the interpolation can also occur at a remote terminal that receives such images. Under such circumstances when remote rendering occurs, the telepresence process 800 of FIG. 8 follows process path 804 following step 803, rather than process path 804 as discussed above. Process path 804 leads to a process block 810 whose first step 811, when executed, triggers the transmission of the of the first and second images to the remote terminal. Following step 812, the remote terminal undertakes interpolation of the two images during step 812. Thus, the step 812 lies below the line 807 demarcating the operations performed by the local and remote terminals. Following step 812, execution of the steps within the process block 830 occur as described previously.

As discussed previously, the monitor at a terminal (e.g., the monitor 210 of terminal 201 of FIG. 2), displays the cropped image during step 840, with cropped signal generated by taking into account the information stored in the database 841 indicative of the position of the cameras with respect to the monitor displaying that image, as well as the physical size of the pixels, and the physical size of the monitor and the pixel resolution used to scale the cropped synthetic image. The scaling performed in connection with the step 840 using information stored in the database 841 can occur within the input signal module or the monitor 210, or divided between these two elements. If the input signal processing module performs such scaling, then the input signal processing module will need to access the database 841 to determine the proper scaling and positioning for the cropped image. If the monitor performs scaling of the cropped image, then cropped image will undergo display at a predetermined size, e.g., fifteen inches tall. Under such circumstances, the input signal processing module will need to expand the bounding box originally destined to be about nine inches tall, by a factor of about 5/3, or six inches vertically, to meet the predetermined height expectation, regardless of the number of pixels in the final cropped image. The monitor would then accept this cropped image for display at the proper location, modifying the image resolution as needed to display the image at the predetermined height.

The telepresence process 800 of FIG. 8 ends at step 842. Note that the steps of this process get repeated twice, once for each terminal as the terminal sends the outgoing image of its local participant and as the terminal processes the incoming image of the remote participant. Further, the steps of the telepresence process 800 are repeated continuously (though not necessarily synchronously), for additional image pairs captured by camera pairs 120 and 130 and 220 and 230 of FIGS. 2.

Rather than perform the face detection, cropping and scaling at the remote terminal (i.e., the terminal that receives the image of a remote participant), such operations could occur at the local terminal, which originates such images. Under such a scenario, the telepresence process of FIG. 8 will follow the process path 806 to the process block 850 whose first step 851, when executed, triggers interpolation of captured images of the local video conference participant to yield a synthetic image. Next, step 830′ undergoes execution to produce a cropped image. Execution of step 830′ typically includes the various operations performed during the process block 830 described previously. Following step 830, the local terminal sends the cropped image to the remote terminal during step 853 for subsequent display during step 840 as previously described. Since the process block 850 undergoes execution by the local terminal, this process block lies above the line 807 which demarcates the operations performed by the local and remote terminals.

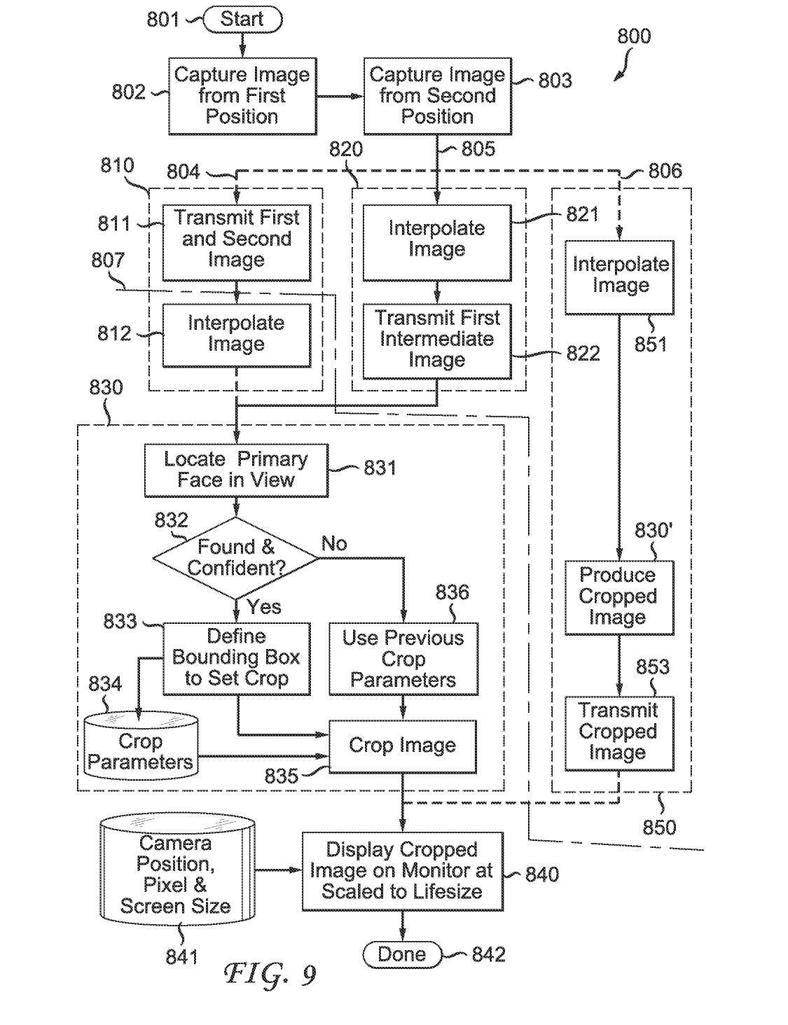

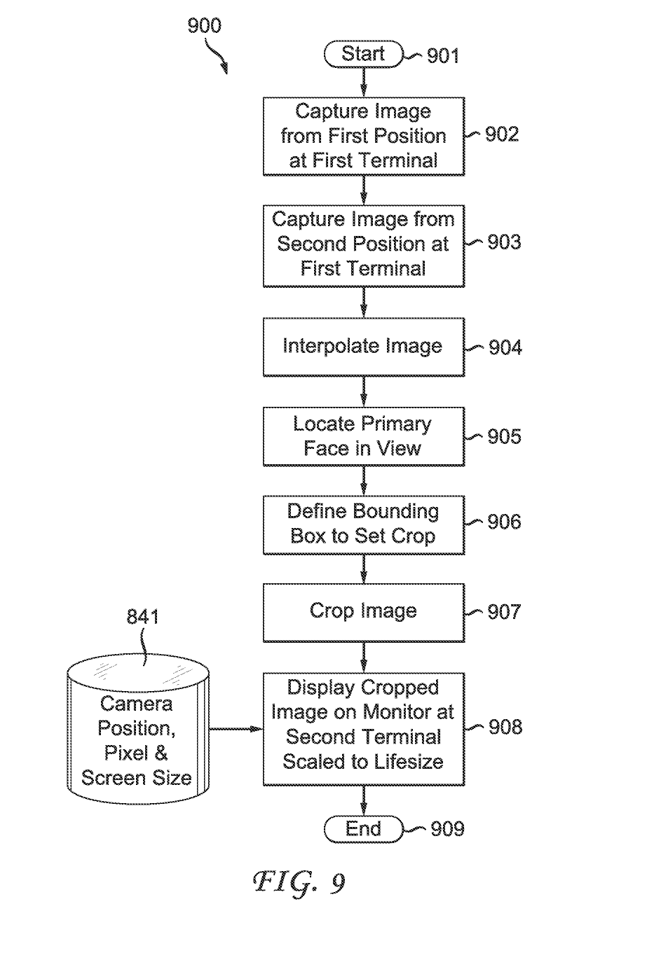

FIG. 9 illustrates, in flow chart form, the steps of a streamlined telepresence process 900. As will become better understood hereinafter, the telepresence process 900 includes similar steps to those described for the process 800 of FIG. 8. The process 900 of FIG. 9 starts upon execution of the step 901 when a first terminal (e.g., terminal 100 of FIG. 2 connects with the terminal 200 of FIG. 2). During steps 902 and 903, the cameras at a first terminal capture images of the local video conference participants at a first and second positions (right and left or top and bottom depending on the orientation of the cameras). Following step 903, the interpolation module of the local terminal generates a synthetic image from the stereoscopic image pair captured by the cameras during step 904. Next, the synthetic image undergoes examination during step 905 to locate the face of the video conference participant.

Thereafter, execution of step 906 occurs to circumscribe the face detected during step 905 with a bounding box to enable cropping of the image during step 907. The cropped image undergoes display during step 908 in accordance with the information stored in the database 841 described previously. The telepresence process 900 of FIG. 9 ends at step 909.

As with the telepresence process 800, the telepresence process 900 undergoes execution at the local and remote terminals. As discussed above with respect to the telepresence process 800, the location of execution of the steps can vary. Each of the local and remote terminals can execute a larger or smaller number of steps, with the remaining steps executed by the other terminal. Further, execution of some steps could even occur on a remote server (not shown) in communication with each terminal through the communication channel 150.

To display the face of the remote video conference participant approximately life-sized, the cropped synthetic image representative of that participant undergoes scaling, based on the information stored in the database 841 describing the camera position, pixel size, and screen size. As described above with respect to the telepresence processes 800 and 900 of FIGS. 8 and 9, the scaling occurs at the terminal, which displays the image of the remote video conference participant. However, this scaling could take place at any location at which a terminal has access to the database 841 or access to predetermined scaling information. Thus, the local terminal, which performs image capture, could perform the scaling. Further, the scaling could take place on a remote server (not shown).

While displaying the image of the remote participant approximately life-sized remains desirable, achieving the eye-contact effect does not require such life-size display. However, life-size display substantially improves the “telepresence effect” because that the local participant will more likely feel a sense of presence of the remote participant.

The telepresence processes 800 and 900 of FIGS. 8 and 9 do not explicitly provide for background detection and rendering of the background as transparent. For systems that choose to render the background region (e.g., the background region 501 of FIG. 5,) transparent, as discussed above respect to FIG. 7, the detection of the background regions and replacement or tagging of those regions as transparent can occur during one of several processing steps. In embodiments which control the background by maintaining relatively constant chrominance or luminance (e.g., chroma-blue screen or a black backdrop), determination of the background color or light level can occur (a) in the camera, (b) after the images have been captured, but before processing, (c) in the synthetic image, (d) in the cropped image, or (e) as the image undergoes displayed. Wherever determined, the color or luminance corresponding to the background can undergo replacement with a value corresponding to transparency. In a another common embodiment, the detection of the background can occur by detecting those portions of the image that remains sufficiently unchanged over a sufficient number of frames, as mentioned above.

In yet another embodiment, detection of the background can occur during the interpolation of the synthetic image, where disparities between the two images undergo analysis. Regions of one image that contain objects that exhibit more than a predetermined disparity with respect to the same objects found in the other image may be considered to be background regions. Further, these background detection techniques may be combined, for instance by finding unchanging regions in the two images, and noticing the range of disparities observable in such regions. Then, when changes occur due to moving objects, but these objects have disparities within the previously observed ranges, then the moving object may be considered as part of the background, too.

The foregoing describes a technique for maintaining eye contact between participants in a video conference.

1. A method for maintaining eye contact between a remote and a local video conference participant comprising the step of
displaying a face of a remote video conference participant to a local video conference participant with the remote video conference participant having his or her eyes positioned in accordance with information indicative of image capture of the local video conference participant.

2. The method according to claim 1 further including the step of scaling the face of the remote video conference participant.

3. The method according to claim 2 wherein the face of the remote video conference participant is scaled to life size.

4. The method according to claim 2 wherein the scaling occurs in accordance with metadata specifying face size.

5. A method for conducting a video conference between first and second video conference participants, comprising the steps of:
capturing at least one stereoscopic image pair of the first video conference participant;
interpolating the at least one stereoscopic image pair to yield a first image for transmission to the second participant, said interpolating being with respect to a point on a display observed by the first participant;
receiving an incoming second image of the second video conference participant; and
displaying a face of the second video conference participant so that his or her eyes appear substantially centered at the point.

6. The method of claim 5 wherein the receiving step further includes the steps of
examining the second image to locate the face; and
processing the second image to center the face within the second image.

7. The method according to claim 6 wherein processing of the second image comprises the steps of:
circumscribing the detected face with a bounding box; and
cropping the second image using the bounding box.

8. The method according to claim 6 further including the step of scaling the face.

9. The method according to claim 8 wherein the face is scaled to life size on the display.

10. The method according to claim 6 wherein the scaling occurs in accordance with metadata specifying face size.

11. The method according to claim 5 wherein the face is positioned in the display in accordance with information indicative of at least one of: (a) image capture position of the at least stereoscopic image pair, display pixel size, and screen size of the display.

12. A terminal for conducting a video conference between first and second video conference participants, comprising the steps of:
at least a pair of television cameras for capturing at least one stereoscopic image pair of the first video conference participant;
means for interpolating the at least stereoscopic image pair to yield a first image for transmission to the second participant;
an input signal processing module for processing an incoming second image of the second video conference participant; and,
a display coupled to the input signal processing module for displaying a face of the second video conference participant with the face of the second video conference participant positioned so that his or her eyes appear substantially at a point on the display;
wherein, said cameras are disposed about the display and the interpolation occurs with respect to positions of the cameras and the point on the display.

13. The terminal according to claim 12 wherein the input signal processing module examines the second image to locate the face and processes the second image to center the face within the second image.

14. The terminal according to claim 12 wherein the input signal processing processes the second image by circumscribing the face with a bounding box and cropping the second image using the bounding box.

15. The terminal according to claim 12 wherein the input signal processing scales the face.

16. The method according to claim 8 wherein the face is scaled to life size.

17. The method according to claim 6 wherein the scaling occurs in accordance with metadata specifying face size.
